(19) United States
(12) Patent Application Publication
(10) Pub. No.: US 2026/0180949 A1
(43) Pub. Date: Jun. 25, 2026

(54) PLANNING OVER-THE-AIR NETWORK SYNCHRONIZATION TOPOLOGY WITH KNOWLEDGE TRANSFER

(71) Applicant: Telefonaktiebolaget LM Ericsson (publ), Stockholm (SE)

(72) Inventors: Tahar ZANOUDA, Solna (SE); Alexandra MIKAELSSON, Tyresö (SE); Marie ARRIVAT, Paris (FR); Mikael JOHANSSON, Solna (SE)

(73) Assignee: Telefonaktiebolaget LM Ericsson (publ), Stockholm (SE)

(21) Appl. No.: 19/127,596

(22) PCT Filed: Nov. 1, 2023
(86) PCT No.: PCT/EP2023/080483

§ 371 Date: May 6, 2025

Related U.S. Application Data
(60) Provisional application No. 63/423,170, filed on Nov. 7, 2022.

(51) Int. Cl. H04L 61/103

(52) U.S. Cl. CPC H04L 61/103

(57) ABSTRACT

A computer-implemented method performed by a computing device to select a over the air network synchronization topology in a planned target network is provided. The method includes identifying first pairs of antenna reference points, ARPs, in a source network; generating a first representation of the first pairs of ARPs; and generating a second representation of second pairs of ARPs in the planned target network. The method further includes using a trained machine learning, ML, model including transferred knowledge of learned similarities to classify respective pairs as at least one of similar and dissimilar in the planned target network; and selecting a subset of the second pairs of ARPs based on an identification of a minimum number of ARPs classified as similar that meet a criteria. The selected subset defines the over the air network synchronization topology.

### TECHNICAL FIELD

The present disclosure relates generally to a computer-implemented method performed by a computing device to select a over-the-air network synchronization topology in a planned target network, and related methods and apparatuses.

### BACKGROUND

Fifth generation (5G) and sixth generation (6G) wireless communication networks are envisioned to provide enhanced end-user quality-of-experience (QoE) and unlock more time-critical and industrial applications. The evolving requirements for such use cases have made time synchronization critical. 5G and 6G wireless communication technologies are dependent on network synchronization and network synchronization time alignment between antenna reference points (ARPs) in the communication network.

Network synchronization implementations may traditionally seek to minimize a relative Time Error (rTE) at the ARPs of all radio access network (RAN) nodes in a communication network to the Common Reference Time (CRT), by continuously adjusting each radio access network node's clock to a local reference that has traceability to the CRT. The CRT may be, for example, a global positioning system (GPS) system time. At each radio access network node, the local reference can be provided by a global navigation satellite system (GNSS) receiver that receives a CRT. Alternatively, a CRT can be carried over the backhaul network, e.g., via a timing protocol such as Precision Time Protocol (PTP), to the radio access network nodes. Thus, a direct time alignment requirement between ARPs (e.g., rTEs) may be achieved by regulating each radio access network node's clock to be within certain time errors (TEs) of the CRT. 5G may be gaining attention as a possible synchronization distribution method, but challenges remain such as lack of efficient synchronization that addresses a variety of scenarios. See e.g., 5G synchronization requirements and solutions, https://www.ericsson.com/en/reports-and-papers/ericsson-technology-review/articles/5g-synchronization-requirements-and-solutions (accessed on 3 Nov. 2022).

### SUMMARY

There currently exist certain challenges. As referenced above, existing approaches may seek to implement network synchronization at ARPs of RAN nodes by minimizing a rTE at the ARPs without the use of over-the-air/5G channels. Such approaches may include challenges. For example, such approaches using trial and error may not be scalable. In dense networks, the number of possible cell pair candidates is large. Thus, it may be very difficult to assess faulty relations. Due to hardware limitations and network configurations, it may be impractical to use a high number of cell connections. Determining which relations between ARP pairs of RAN nodes are reliable may be a labor-intensive process. Moreover, in green field deployments, a network may be planned and then seeking to optimize a network synchronization configuration may occur after deployment of the network. As a consequence, optimization of network synchronization before deployment may be lacking. Additionally, some existing approaches may not model relations between ARPs as a multidimensional (e.g., technological, geospatial, etc.) entity, and also may lack consideration of geospatial and demographic changes. With increasing traffic demand, there may be a trend towards network densification. Thus, growing complexity and diversity of 5G synchronization requirements and limitations may have imposed significant challenges to effectively find topological configurations and robust network synchronization solutions (e.g., optimal solutions).

Certain aspects of the disclosure and their embodiments may provide solutions to these or other challenges.

In some embodiments, a computer-implemented method performed by a computing device is provided to select a over the air network synchronization topology in a planned target network. The method includes identifying a plurality of first pairs of ARPs in a source network; generating a first representation of the plurality of first pairs of ARPs in the source network; and generating a second representation of a plurality of second pairs of ARPs in the planned target network. The method further includes using a trained ML model including transferred knowledge of learned similarities between the plurality of first pairs of ARPs in the first representation, to classify respective pairs as at least one of similar and dissimilar from the second representation of the plurality of second pairs of ARPs in the planned target network. The method further includes selecting a subset of the second pairs of ARPs based on an identification of a minimum number of ARPs from the respective pairs classified as similar that meet a criteria. The selected subset defines the over the air network synchronization topology in the planned target network.

In some embodiments, a computing device configured to select a over the air network synchronization topology in a planned target network is provided. The computing device includes processing circuitry; and memory coupled with the processing circuitry. The memory includes instructions that when executed by the processing circuitry causes the computing device to perform operations. The operations include to identify a plurality of first pairs of ARPs in a source network; generate a first representation of the plurality of first pairs of ARPs in the source network; and generate a second representation of a plurality of second pairs of ARPs in the planned target network. The operations further include to use a trained ML model including transferred knowledge of learned similarities between the plurality of first pairs of ARPs in the first representation, to classify respective pairs as at least one of similar and dissimilar from the second representation of the plurality of second pairs of ARPs in the planned target network. The operations further include to select a subset of the second pairs of ARPs based on an identification of a minimum number of ARPs from the respective pairs classified as similar that meet a criteria. The selected subset defines the over the air network synchronization topology in the planned target network.

In some embodiments, a computing device configured to select a over the air network synchronization topology in a planned target network is provided. The computing device is adapted to perform operations. The operations include to identify a plurality of first pairs of ARPs in a source network; generate a first representation of the plurality of first pairs of ARPs in the source network; and generate a second representation of a plurality of second pairs of ARPs in the planned target network. The operations further include to use a trained ML model including transferred knowledge of learned similarities between the plurality of first pairs of ARPs in the first representation, to classify respective pairs as at least one of similar and dissimilar from the second representation of the plurality of second pairs of ARPs in the planned target network. The operations further include to select a subset of the second pairs of ARPs based on an identification of a minimum number of ARPs from the respective pairs classified as similar that meet a criteria. The selected subset defines the over the air network synchronization topology in the planned target network.

In some embodiments, a computer program is provided that includes program code to be executed by a processing circuitry of a computing device configured to select a over the air network synchronization topology in a planned target network. Execution of the program code causes the computing device to perform operations. The operations include to identify a plurality of first pairs of ARPs in a source network; generate a first representation of the plurality of first pairs of ARPs in the source network; and generate a second representation of a plurality of second pairs of ARPs in the planned target network. The operations further include to use a trained ML model including transferred knowledge of learned similarities between the plurality of first pairs of ARPs in the first representation, to classify respective pairs as at least one of similar and dissimilar from the second representation of the plurality of second pairs of ARPs in the planned target network. The operations further include to select a subset of the second pairs of ARPs based on an identification of a minimum number of ARPs from the respective pairs classified as similar that meet a criteria. The selected subset defines the over the air network synchronization topology in the planned target network.

In some embodiments, a computer program product including a non-transitory storage medium including program code to be executed by processing circuitry of a computing device is provided. Execution of the program code causes the computing device to perform operations. The operations include to identify a plurality of first pairs of ARPs in a source network; generate a first representation of the plurality of first pairs of ARPs in the source network; and generate a second representation of a plurality of second pairs of ARPs in the planned target network. The operations further include to use a trained ML model including transferred knowledge of learned similarities between the plurality of first pairs of ARPs in the first representation, to classify respective pairs as at least one of similar and dissimilar from the second representation of the plurality of second pairs of ARPs in the planned target network. The operations further include to select a subset of the second pairs of ARPs based on an identification of a minimum number of ARPs from the respective pairs classified as similar that meet a criteria. The selected subset defines the over the air network synchronization topology in the planned target network.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a flow chart illustrating operations of a computing device in accordance with some embodiments;

FIG. 2 is a flow chart illustrating operations of a computing device in accordance with some embodiments;

FIG. 3 is a schematic diagram illustrating a map/representation of data of an example embodiment;

FIG. 4 is a schematic diagram illustrating an example of extracted data for a node ARP pair of an example embodiment;

FIG. 5 is a schematic diagram illustrating an example of a cycle;

FIG. 6 is a flow chart illustrating operations of an example embodiment to identify unreliable measurement in a source network using cycles;

FIG. 7 is a schematic diagram illustrating operations of an example embodiment to generate embeddings for a cell relation;

FIG. 8 is a schematic diagram illustrating an example embodiment of training a ML model;

FIG. 9 is a flow chart of operations for training a ML model; in accordance with some embodiments of the present disclosure;

FIG. 10 is a schematic diagram illustrating an example embodiment of results of the selection of anchor nodes in a graph;

FIG. 11 is a block diagram of a cloud environment in which some embodiments of the present disclosure can be implemented;

FIG. 12 is a block diagram of a communication system in accordance with some embodiments;

FIG. 13 is a block diagram of a user equipment in accordance with some embodiments

FIG. 14 is a block diagram of a network node in accordance with some embodiments;

FIG. 15 is a block diagram of a host computer communicating with a user equipment in accordance with some embodiments;

FIG. 16 is a block diagram of a virtualization environment in accordance with some embodiments;

FIG. 17 illustrates one implementation example for particular embodiments of the present disclosure;

FIG. 18 illustrates an alternative implementation example for particular embodiments of the present disclosure; and

FIG. 19 illustrates three examples of a computing device that may be used to implement particular embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents some embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Mobile operators may typically rely on trial-error processes for newly designed technology (e.g., which may be common for new 5G capabilities). Mobile operators may tend to conduct field trials where performance of new services such as 5G synchronization are monitored to mitigate network failures or avoid performance degradation. Problems, however, may often occur from a lack of knowledge to configure new technologies in the deployed network. Moreover, network planning may not only rely on network data and RAN configurations, but it considers built-up infrastructure and topographic factors as well.

Some approaches may have drawbacks. Some existing approaches may seek to implement network synchronization at ARPs of RAN nodes by minimizing a rTE at the ARPs without the use of over-the-air/5G channels. Such approaches may use trial and error may not be scalable. In dense networks, the number of possible cell pair candidates is large. Thus, it may be very difficult to assess faulty relations. Due to hardware limitations and network configurations, it may be impractical to use a high number of cell connections. Determining which relations between ARP pairs of RAN nodes are reliable may be a labor-intensive process. Moreover, in green field deployments, a network may be planned and then seeking to optimize a network synchronization configuration may occur after deployment of the network. As a consequence, optimization of network synchronization before deployment may be lacking.

Additionally, some existing approaches may not model relations between ARPs as a multidimensional (e.g., technological, geospatial, etc.) entity, and also may lack consideration of geospatial and demographic changes. With increasing traffic demand, there may be a trend towards network densification. Thus, growing complexity and diversity of 5G synchronization requirements and limitations may have imposed significant challenges to effectively find topological configurations and robust network synchronization solutions (e.g., optimal solutions). One of the challenges that mobile operators may face is to accommodate a high number of cells without significantly increasing operational and infrastructure costs.

Thus, growing complexity and diversity of 5G synchronization requirements and limitations may have imposed significant challenges to effectively find optimal topological configurations and robust network synchronization solutions.

As referred to herein, the term “relations” refers to relations between RAN nodes that have antenna(s) that can “hear” each other and, thus, can perform over-the-air time alignment measurements and provide synchronization over-the-air to each other.

Certain aspects of the disclosure and their embodiments may provide solutions to these or other challenges. A communication network includes a set of interconnected nodes (including ARPs) located on physical sites. Each cell in a site provides coverage in a geographical area and often is linked to neighboring cells to facilitate communication functionalities (e.g., over-the-air synchronization, handover, etc.). Each link between a cell and its neighboring cell can be referred to as a “relation”. Cell relations include pairs of cells, where each cell is characterized by a set of configuration parameters (azimuth, etc.) with a corresponding set of performance indicators (throughput, etc.). An observability system can be used to passively monitor system performance and signal faults.

A software (SW) feature may allow the use of a 5G channel between ARPs to maintain a RAN node's clock when its primary reference is disabled. While such a SW feature may also implement a feature for synchronizing the ARP through the 5G channel without the need for additional local references, this may require that the 5G channel between ARPs fulfills necessary characteristics.

To efficiently utilize the capabilities of 5G to distribute synchronization, it may be necessary to know at the planning stage of a new 5G rollout which ARP pairs in the network will have a 5G link between themselves that is good enough for synchronization. Having that knowledge in advance may allow smarter and more cost-efficient synchronization solutions in which only few nodes (referred to herein as “anchor nodes”) need a local time reference (e.g., a GNSS receiver), and the rest are synchronized over the 5G channel.

Thus, for a network in operation, 5G link quality between ARP pairs in a RAN may be obtained by using features of measuring time alignment between the ARPs. Transferring that knowledge from an operational network to a new planned network may improve drawbacks of existing approaches.

In an example, operations are provided to plan a network synchronization topology for a planned target network by transferring knowledge regarding ARP-ARP channel quality from an existing source network.

A neural network(s) can be used to model and generate a deep representations for each ARP pair in an operational source network, and then transfer knowledge from the operational source network to a planned target network using similarity learning.

In some operations, a process is provided to find reliable ARP pairs created in an operating source network and use such pairs to transfer knowledge from the source network to the planned target network.

The operations may provide a process to find reliable ARP pairs in a planned target network.

The operations may further provide a technique to select an optimal set of anchor nodes in the planned target network.

Technical advantages provided by certain embodiments of the present disclosure may include that based on inclusion in the method of modeling and transferring synchronization settings from a deployed source network to selected pairs of ARPs in the planned target network, network synchronization planning may be optimized or improved. For example, the method may allow the use of a 5G channel between ARPs to maintain a RAN node's clock when its primary reference is disabled based on leveraging machine learning (ML) techniques which may result in efficiently managing and automating the process of planning new synchronization relations in planned target network deployments. Moreover, based on the inclusion of the transfer of knowledge, the method may be scalable and may be used for any target mobile network.

Further, the method may reduce or minimize efforts to evaluate synchronization relations by alleviating expenses for tasks that are often handled by testers and experienced network engineers as well as troubleshooting activities.

For ease of discussion, example embodiments herein are explained in the non-limiting context of a 5G source network and a 5G planned target network that respectively include gNodeB (gNB) ARP pairs. The present disclosure, however, is not so limited and some embodiments include other radio access technologies (e.g., 6G) and nodes other than gNBs (e.g., such as evolved NodeBs (eNBs), etc.).

As used herein, the term “network node” refers to, without limitation, a base station, a gNodeB (gNB), and evolved NodeB (eNB), etc. The terms “network node” and “node” herein are interchangeable.

Operations are provided to plan node (e.g., gNB) ARP pairs for a target network. The operations can include the following:
1. Data collection (referred to herein as “Operation 1”): Operation 1 can consider two data sources:
   Live network data such as site configuration data, and
   Urban Infrastructure data such as spatial data for regions where the network is deployed (e.g., type of terrain).
2. Extract synchronization node ARP from deployed source network (referred to herein as “Operation 2”).
3. Identify robust and reliable node ARP pairs (referred to herein as “Operation 3”)
4. Generate representations for reliable node ARP pairs (referred to herein as “Operation 4”).
5. Train a ML model to learn similarity between node ARP pairs. For example, a Siamese neural network may be used to learn similarity and overcome problems of limited data (referred to herein as “Operation 5”).
6. Generate node ARP pairs in the target network of interest. For example, a trained Siamese neural network may be used to estimate the reliability of setting a new relation (referred to herein as “Operation 6”).
7. Identify anchor nodes in a graph of node ARP pairs (referred to herein as “Operation 7”).

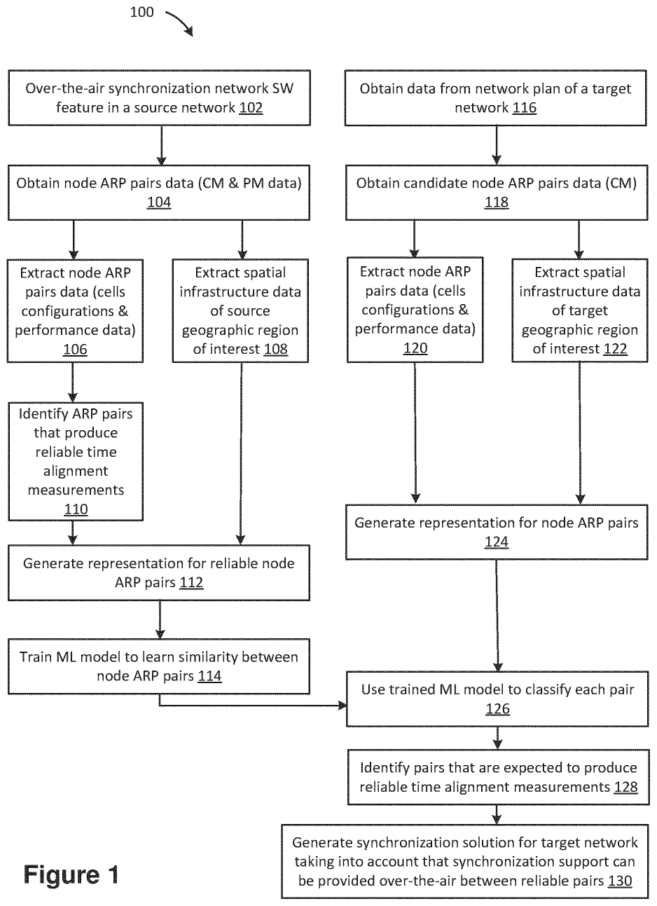

FIG. 1 is a flow chart 100 illustrating Operations 1-7 performed by a computing device. In the discussion that follows, the above seven operations are referred to as Operation 1-Operation 7. The operations from the flow chart of FIG. 1 may be optional with respect to some embodiments of computing devices and related methods. For example, operations of blocks 102-108, 114-122. 128 may be optional.

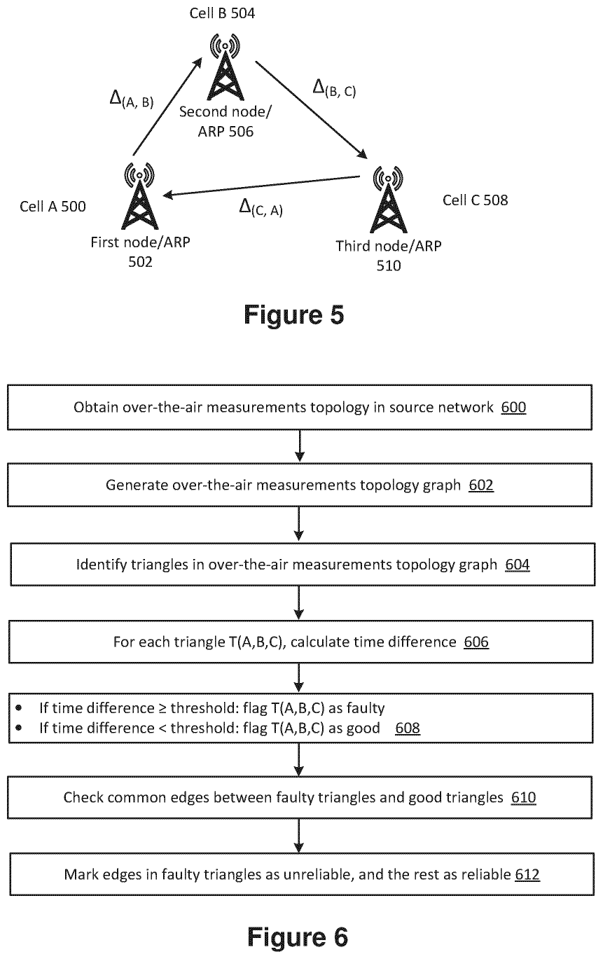

Operations of a computing devices can be performed by any one of 502, 506, 510, 17100, or 18000 of FIG. 5, 17, 18, or 19. Operations of the computing device (implemented using the structure from any one of FIG. 14, 17, 18, or 19) are discussed further herein according to some embodiments of the present disclosure. For example, modules may be stored in at least one memory 14304, 17102, 18102, 19518, 19548 of FIG. 14, 17, 18, or 19, and these modules may provide instructions so that when the instructions of a module are executed by respective computing device processing circuitry 14302, 17101, 18101, 19512, 19542 of FIG. 14, 17, 18, or 19, computing device 502, 506, 510, 17100, or 18000 performs respective operations of the flow chart. In some embodiments, the computing device includes one of a centralized computing device communicatively connected to the source network and the planned target network, and a distributed cloud-based computing devices including one or more of the following modules (discussed further herein) (i) a data collection module, (ii) a over-the-air measurement assessment module, and (iii) a cross-network knowledge transfer module.

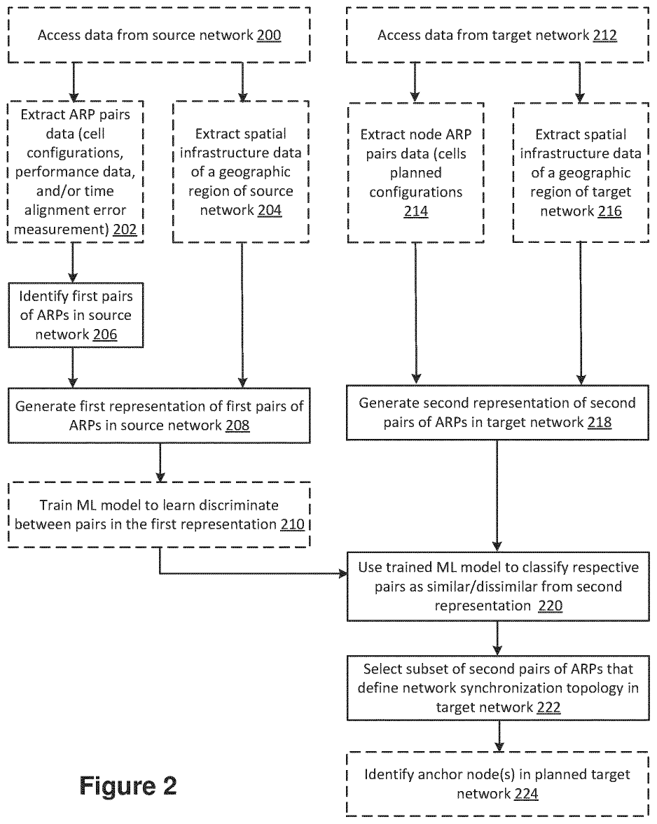

Various operations from the flow chart of FIG. 2 may be optional with respect to some embodiments of computing devices and related methods. For example, the operations of blocks 200-204, 210-216, and 224 of FIG. 2 may be optional.

Referring to FIG. 1, operations of blocks 102-114 are performed for a deployed source network, and operations of blocks 116-130 are performed for a planned target network.

The data collection of Operation 1 can include the operations of blocks 102-106 for the source network, and blocks 116-120 for the planned target network.

For the source network, a SW feature, illustrated in FIG. 1 as an over-the-air time alignment measurements software (SW) feature is deployed 102 in an operational source network. The SW feature can allow, e.g., use of a telecommunications channel (e.g., a 5G channel) between deployed ARPs to maintain a node's clock when its primary reference is disabled. The SW feature is used to obtain 104 node ARP pairs data including configuration management (CM) and performance management (PM) data.

For the planned target network, data is obtained 116, 118 from a network plan of a target network. The data can include candidate node ARP pairs data (e.g. configuration management (CM) data such as cell configurations).

For the source network, in block 106, node ARP pairs data is accessed from the data obtained in block 104. For the planned target network, candidate node pairs data is accessed 118 from the data obtained in block 116.

In blocks 106 (for the source network) and block 120 (for the target network), ARP pairs data is obtained. The ARP pairs data includes two data streams: network data and spatial infrastructure data.

In the example of FIG. 1, network data for the source network includes information about cell configuration attributes and performance management (PM) data, such as, for each node ARP pair, antenna positions, directions, transmission power, and an over-the-air measurement result(s) (e.g., signal quality and signal path loss; time alignment error measurements from the deployed source network). For the planned target network, the network data can include at least one or more of the following data: cell configuration; antennas position; expected signal quality and expected signal path loss.

Spatial infrastructure data includes extracted data 108 (for the source network), 122 (for the target network) from spatial multi-source data geographic properties of a respective tile for the source network and the planned target network. Spatial data can include, but is not limited to, a building layer, points of interest (POIs), a type of terrain, etc. Currently, some approaches rely only on telecommunications data. However, environmental conditions can play a role in how a signal propagates and how a synchronization functionality works. In contrast, in the example of FIG. 1, the following data is collected: a building footprint to capture the shape and size of buildings; and POIs (e.g., bus stations, airport, etc.) and land use information (e.g., commercial, educational, etc.) to understand the traffic patterns and location (e.g., a city) attractors over time.

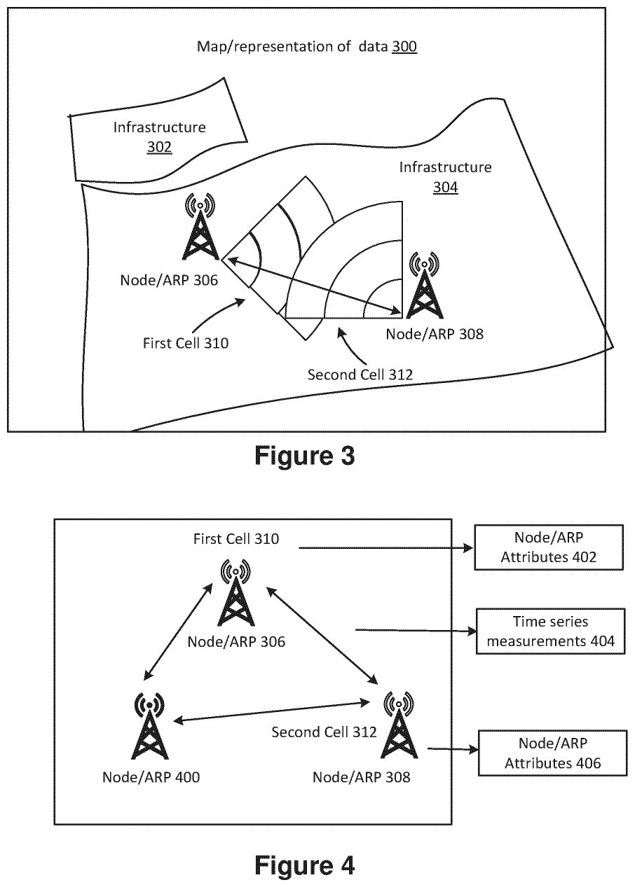

FIG. 3 is a schematic diagram illustrating a map/representation of data 300 collected from a node ARP pair 306, 308 in first and second cells 310, 312, respectively, and/or infrastructure 302, 304 for which data is collected from a source network or from a planned target network.

The extraction of Operation 2 can include the operation of block 108 for the source network. Extraction can be performed, e.g., to understand and label behavior of a time alignment of the SW feature of block 102 to try to deploy reliable relations in the planned target network. To try to achieve this, in the example of FIG. 1, data is processed from the source network or a controlled environment where the SW feature has been deployed.

FIG. 4 is a schematic diagram illustrating an example of extracted data for a node ARP pair 306, 308. In this example, node/ARP 400 is not included in a node ARP pair. For the node ARP pair 306, 308 of the first cell 310. Attributes 402 are extracted for node/ARP 306, and attributes 406 are extracted for node/ARP pair 308. Additionally, time series measurements 404 are extracted for the node/ARP pair 306, 308. The extracted node APR pairs data can be stored in managed object (MO) classes. When the SW feature is activated, the SW feature can capture time-series data, referred to herein as time alignment error measurements. PM data can be used to gauge SW feature performance. PM data may be captured at regular intervals. A time alignment error PM counter can come as a scalar. Table 1 below illustrates an example of node ARP pair attributes data, Table 2 below illustrates an example of node ARP PM data, and Table 3 below illustrates another example of a list of node ARP PM data.

TABLE 1
Node ARP pair configuration data

Data collection time
Global Cell ID for each pair
Radio technology generation (e.g., 4G, 5G, 6G, etc.)
The downlink channel bandwidth in the cell for each pair.
The uplink channel bandwidth in the cell for each pair.
The azimuth for each pair.
The distance between pairs
Etc.

TABLE 2
Node ARP Time Alignment Relation data

Data collection time
Node ARP Global Cell IDs
Measurement related data
Etc.

TABLE 3
Node ARP pair PM data

Data collection time
gNB ARP Global Cell IDs
Time Alignment Error Counter

Identifying ARP pairs that produce reliable time alignment measurements of Operation 3 can include the operation of block 110 of FIG. 1. Once the time alignment error data is collected, historical time-series measurements can be labeled using the following procedure.

A check can first be performed to see if the feature is already activated and if the cell is already operational. Attributes used for this can include an availability status, an operational status, and a measurement quality. These attributes, for example, can indicate whether the measurement is captured because it was unreliable, or because of other operational settings. At this stage, some of the measurements can be labeled as unreliable.

Time alignment error data can be in the form of a time-series of data. Each data point can represent a time alignment error measurement of a node ARP.

While this example includes an existing measurement quality attribute that assesses the reliability of a measurement in a pro-active manner, some measurements assessed as reliable still may be untrustworthy for a variety of reasons (e.g., due to quality or external factors (e.g., direction of an antenna, an alignment issue, an environmental factor, etc.). Such cases can be identified by leveraging “cycles” in the network, as discussed below.

The topological structure of the source network can be used to obtain the cycles in the source network. FIG. 5 is a schematic diagram illustrating an example of a cycle of size 3 (e.g., a triangle as illustrated by 3 edges between first node/ARP 502 in Cell A 500 and second node/ARP 506 in cell B 504, between second node/ARP 506 and third node/ARP 510 in cell C 508, and between third node/ARP 510 and first node/ARP 502).

In an ideal scenario, the sum of a time difference can be equal or close to 0 within each cycle. In FIG. 5 for example, given three cells A 500, B 504 and C 508 that form a cycle (here, a triangle), the sum of the time difference in an ideal scenario can be close or equal to 0, i.e. Δ_{(A,B)}+Δ_{(B,C)}+Δ_{(C,A)}≈0. The threshold for the total time difference of a cycle can then be close enough to 0 and is set as the Cycle Quality Threshold (or Triangle Quality Threshold in the case of a triangle, for example). If a cycle does not respect that condition, it can be flagged as faulty, and the measurements of its edges are considered unreliable. Otherwise, if a cycle respects that condition, it can be flagged as good, and the measurements of its edges are considered reliable. If an edge is present in a faulty cycle as well as in a good cycle, its measurement can be considered reliable. While this pipeline to identify additional unreliable measurements is described with reference to the example in FIG. 5 and FIG. 6 (discussed below), for cycles of size 3 (e.g., triangles), the present disclosure is not so limited, and cycles of other sizes exceeding two edges may be included.

FIG. 6 is a flow chart illustrating operations to identify unreliable measurement in a source network using cycles, illustrated in this example as a cycle of three corresponding to FIG. 5.

In block 600, an over-the-air measurements topology is obtained for the source network; and in block 602, an over-the-air measurements topology graph is generated from the obtained over-the-air measurements topology.

In block 604, triangle are identified in the over-the-air measurements topology graph. For each triangle T(A, B, C), in block 606, a time difference is calculated to obtain a sum of the time difference: Δ_{τ}=Δ_{(A,B)}+Δ_{(B,C)}+Δ_{(C,A)}

In block 608, the cycle flagged as faulty or good. For example, if Δ_{τ}≥triangle quality threshold: flag T(A, B, C) as faulty; or if Δ_{τ}<triangle quality threshold: flag T(A, B, C) as good.

In block 610, the common edges between faulty triangles and good triangles are check; and in block 612, the edges of faulty triangles are marked as unreliable and the rest of the edges (e.g., in good triangles) are marked as reliable

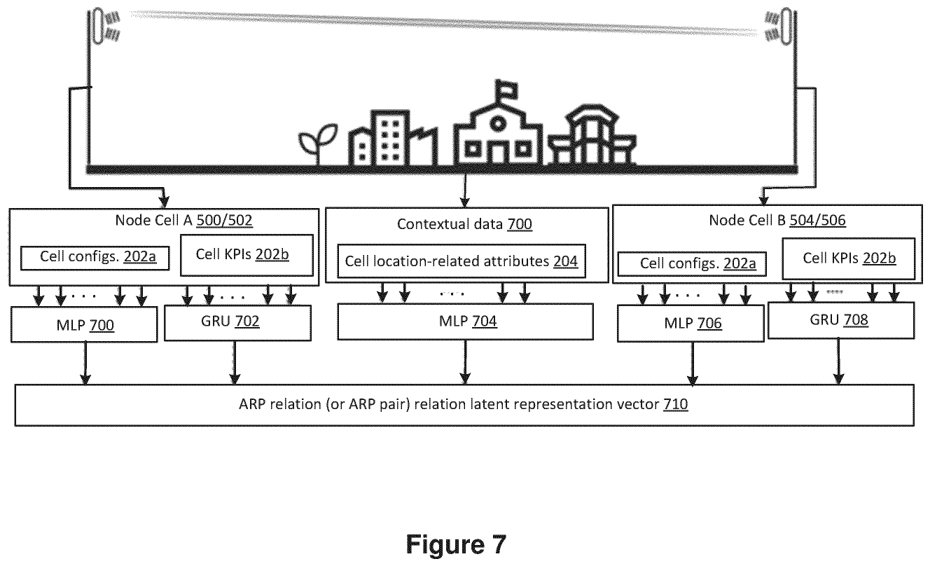

Generating a representation for reliable node ARP pairs of Operation 4 can include operation 112 of FIG. 1. FIG. 7 is a schematic diagram illustrating a process to generate embeddings for each cell relation. Once reliable node ARP pairs are identified from Operation 3, a set of different types of features can be used to generate latent representations. Using such a high-dimensional feature representation may alleviate domain differences. Further, as illustrated in the example of FIG. 7, multi-source data is harnessed and transfer learning techniques is leverage, which may overcome a label scarcity problem.

To generate embedding for node ARP pairs, in the example of FIG. 7 (which corresponds to the example of FIGS. 5 and 6), the two sources for data discussed in Operation 1 are used. That is, (1) node ARP pairs configuration, (2) node ARP pairs key performance indicators (KPIs), and (3) spatial contextual data. FIG. 7 illustrates operations to generate embeddings using the data. Collected node ARP pairs configuration data 202a, 202b for Node ARP pairs 502, 506 and spatial contextual data 7000 including cell location-related attributes 204 is provided to multilayer perceptron (MLPs) 700, 704, 706 and gated recurrent units (GRUs) 702, 708, as illustrated in FIG. 7. Such data may be collected and prepared in a form of tabular data. MLPs 700, 704, 706 may be used to generate deep latent representations of tabular features. On the other hand, node ARP pairs KPIs are temporal data points. Thus, GRUs 702, 708 may create a temporal representation of internal temporal counters. The embeddings produced in the previous step are concatenated to represent 710 node an ARP relation (e.g., ARP pair) using latent representation vectors.

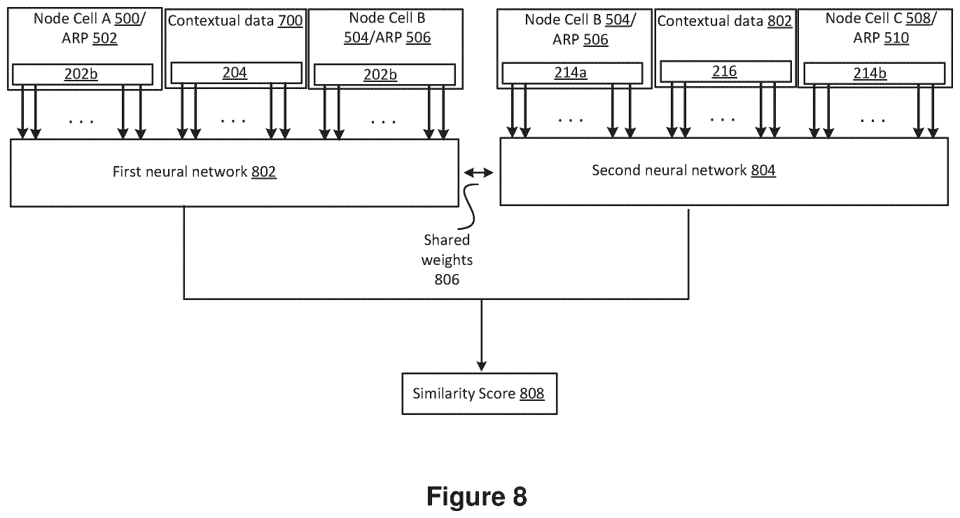

Training a ML model to learn similarity between node APR pairs for Operation 5 can include operation 114 of FIG. 1. FIG. 8 is a schematic diagram illustrating an example of training a ML model. In the illustrated example, in order to compare between two node ARP pairs 502, 506 and 506, 510 using latent representation vectors, a Siamese neural network (NN) architecture is used that can learn to differentiate between two inputs 202b, 204, 202b and 214a, 216 214b. The Siamese NN of this example includes two parallel identical NN components 802, 804 that share weights 806 and a function to calculate the similarity of the outputs of the two NNs 802, 804. The embeddings generated in the example of previous step contain differentiable characteristics. The embeddings are then used as a proxy to calculate the similarity (e.g., similarity score 808) between node ARP pairs 502, 506 and 506, 510. Two node ARP pairs embeddings are similar if they share the same label, and the pairs are considered dissimilar if they do not share the same label.

The weights 806 of the Siamese NN are shared between the two parts of the network 802, 804, which can enable the network to learn similarity and dissimilarity. The ML model can be trained using contrastive loss.

The Siamese NN of FIG. 8 uses training data. In an example, the Siamese NN is trained by teaching that two reliable pairs are similar; two unreliable pairs are dissimilar; and a reliable pair and an unreliable pair are dissimilar. Thus, training data for ARP node pairs can be generated as follows:
For each node ARP pairs (Xᵢ), extract k node ARP pairs (Xₙ) from the same class (e.g., similar). That is, e.g., (Xₙ) reliable if (Xᵢ) reliable, and (Xₙ) unreliable if (Xᵢ) unreliable.
For each node ARP pairs (Xᵢ), extract k node ARP pairs (Xᵣ) not from the same class (e.g., dissimilar). That is, e.g., (Xᵣ) unreliable if (Xᵢ) reliable, and (Xᵣ) reliable if (Xᵢ) unreliable.

An advantage of using a Siamese NN may be to overcome data insufficiency problems. Fine-grained node ARP-level knowledge transfer can be applied to any location (e.g., city) regardless of its size. Location-agnostic contextual features together with KPIs that are present in regions where the SW feature is not deployed yet may be used.

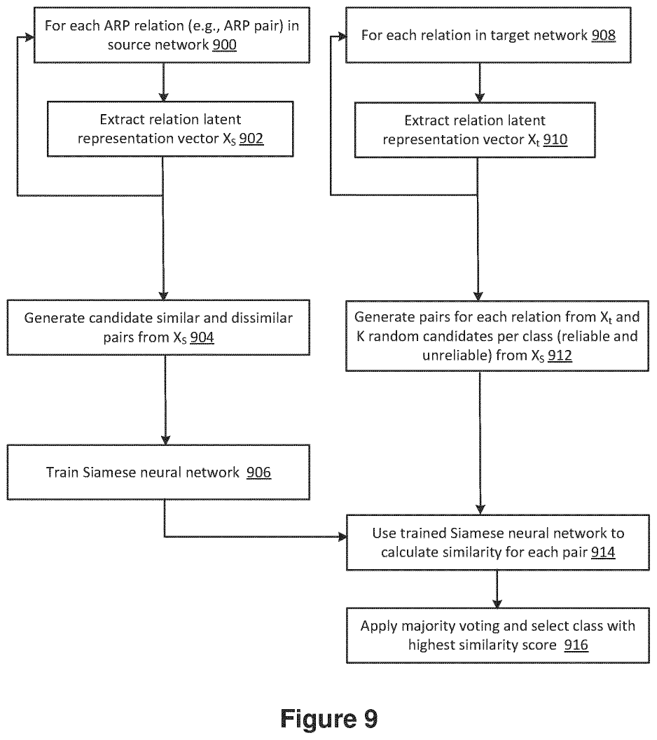

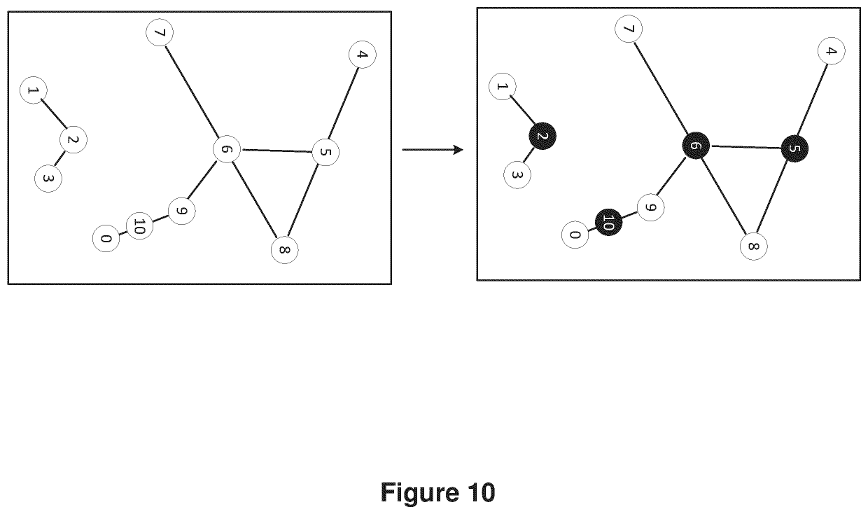

FIG. 9 is a flow chart of operations for training a ML model that corresponds to FIG. 8. In a loop of operations 900 and 902, for each ARP relation (e.g., ARP pair) in the source network, over-the-air synchronization relations are obtained (operation 900). In block 902, over-the-air synchronization relation latent representation vector X_{S} is extracted. Operations then proceed, in block 904, with generating candidate similar and dissimilar pairs from X_{S}. The Siamese NN is then trained in operation 906 with the generated candidate pairs from operation 904.

For the target network, in a loop of operations 908 and 910, for each over-the-air synchronization relation in the target network, over-the-air synchronization relations are obtained (operation 908). In block 910, over-the-air synchronization relation latent representation vector Xₜ is extracted. Operations then proceed, in block 912, with generating pairs for each relation from Xₜ and a K random candidates from each class (e.g., reliable and unreliable classes) from Xₛ. The trained Siamese NN is then used in operation 914 to calculate a similarity for each pair from operation 912. The calculation can be performed as discussed further herein. In operation 916, majority voting is applied and a class is selected that has a highest similarity score. Thus, in an example, K random candidates are taken from each class (e.g., reliable and unreliable) in the source Xₛ; a pair from Xₜ is compared with the pairs from Xₛ; and a majority voting is applied to determine whether the pair from Xₜ is more similar to reliable pairs or to unreliable pairs.

Generating node ARP pairs in the target network for Operation 6 can include operation 124 in FIG. 1. Continuing with example discussed above, once the Siamese NN model is trained, the trained model is used to classify whether two node ARP pairs are similar or dissimilar.

In this example, to do so, all possible node ARP pairs are generated in the target network. From the generated ARP pairs, representation embeddings are generated for each node ARP pair (as discussed previously herein).

For each node ARP pair, k random node ARP pairs are used from each class (that is, similar to reliable pairs, dissimilar to reliable pairs). Then, the trained Siamese NN model is used to assess similarity. If a majority of the similarity scores indicate that the node ARP pair is a reliable pair (e.g., if the pair is mostly similar to reliable pairs), it is labelled (e.g., as a “possible reliable pair” and vice versa). If a majority of the similarity scores indicate that a node ARP pair is not reliable a pair (e.g., if the pair is mostly similar to unreliable pairs), it is labelled accordingly (e.g., as “possible unreliable pair”).

Identifying anchor nodes in the graph of node ARP pairs for Operation 7 can include operation 126-130 in FIG. 1. Continuing with the above example, node ARP pairs that have been classified as reliable pairs are used to construct a graph of node ARP pairs (e.g., with pairs being edges in the graph).

In some cases, the cells can be restricted to a maximal number of connections. In such cases, for each cell, the pairs labeled as, e.g., “possible reliable pairs” involving this cell are ranked based on the average of their similarity scores to reliable pairs obtained with the Siamese NN during the previous operation, from highest to lowest. Then, the top N pairs are kept, with N being the maximal number of connections allowed. These selected 128 node ARP pairs are then used to construct 130 the topology graph of synchronization for the target network.

Continuing with the example, once the graph is constructed, a minimum number of nodes is identified to select in order to reach all the other nodes in the graph, where a selected node reaches the nodes up until k-hop away (e.g., k=1 means a node only reaches its direct neighbors). In this example, the minimum number of nodes is selected as follows.

Given the graph constructed with the selected node ARP pairs, an adjacency matrix is constructed of the graph where a vertex is connected to other vertices that are k-hops away, including itself, and the degree of each vertex is computed. A status dictionary is created that contains the binary status of every vertex and that reflects if a vertex has been reached or not. The conditional degree of each vertex is computed, which captures the number of vertices it is connected to that have not been reached yet. The vertex with a highest conditional degree is selected and added to a minimal set of nodes. The status of this vertex, as well as of all the vertices it is connected to, is then changed to reflect that these vertices have been reached. The conditional degree is then computed again, and the process carries on until all vertices have been reached.

It is noted that nodes can be reached several times, and such nodes are referred to herein as “overlapped nodes”. For a minimal number of nodes needed to reach all nodes, “overlapped nodes” are encouraged. Thus, when selecting the node with highest conditional degree, in case of a draw, the vertex with the highest degree is selected as it permits a maximal number of “overlapped nodes”. If there is still a draw, several alternatives can be given.

Once the minimum number of nodes is identified, in this example, these nodes are labelled as anchor nodes. As used herein, “anchor nodes” are nodes that should have traceability capability to a Primary Reference Time Clock (PRTC).

FIG. 10 is a schematic diagram illustrating an example of results of the selection of anchor nodes in a graph where anchor nodes can reach nodes 1 hop away. As shown in FIG. 10, 4 anchor nodes (node numbers 2, 5, 6, and 10 and shown with black colored circles in FIG. 10) in a graph of 11 nodes were selected, where the selected anchor nodes 2, 5, 6, and 10 can reach nodes at most 1 hop away.

Some embodiments are directed to a method performed by a computing device (e.g., 502, 506, 510, 17100, 18000 of FIG. 5, 17, 18, or 19). Operations of the computing device will now be discussed with reference to the flow chart of FIG. 2 according to some embodiments.

As illustrated in FIG. 2, a computer-implemented method performed by a computing device is provided to select a over the air network synchronization topology in a planned target network. The method includes identifying (206) a plurality of first pairs of ARPs in a source network; generating (208) a first representation of the plurality of first pairs of ARPs in the source network; and generating (218) a second representation of a plurality of second pairs of ARPs in the planned target network. The method further includes using (220) a trained ML model including transferred knowledge of learned similarities between the plurality of first pairs of ARPs in the first representation, to classify respective pairs as at least one of similar and dissimilar from the second representation of the plurality of second pairs of ARPs in the planned target network. The method further includes selecting (222) a subset of the second pairs of ARPs based on an identification of a minimum number of ARPs from the respective pairs classified as similar that meet a criteria. The selected subset defines the over the air network synchronization topology in the planned target network.

The knowledge can include antenna data and radio environment data from the source network.

In some embodiments, identifying (206) the plurality of first pairs of ARPs includes (i) labeling a plurality of historical time-series measurements comprising time alignment error data of a pair from the plurality of first pairs of ARPs as at least one of reliable and unreliable, (ii) identify and label unreliable and reliable ARP pairs, and (iii) use labeled ARP pairs to select pairs of second pairs of ARPs.

In some embodiments, the identifying (206) further includes (I) identifying a plurality of cycles in the first representation of the plurality of first pairs of ARPs in the source network. A cycle includes a time difference between respective ARPs in a group of three or more ARPs, (ii) calculating a sum of the time differences per cycle in the source network, (iii) comparing the sum of the time differences per cycle to a specified cycle threshold, (iv) when a cycle satisfies the cycle threshold, flagging the cycle as acceptable and marking a plurality of edges in the cycle as reliable, (v) when a cycle fails to satisfy the cycle threshold, flagging the cycle as unacceptable and marking a plurality of edges in the cycle as unreliable, and (vi) If an edge is present both in an unacceptable cycle and in an acceptable cycle, the edge is considered reliable.

In some embodiments, the generating (208) a first representation of the plurality of first pairs of ARPs in the source network includes (i) accessing for a pair of ARPs from the first pair of ARPs, data comprising a cell configuration, synchronization key performance indicators, KPIs, including an over the air time alignment measurement and spatial contextual data, (ii) generating embeddings using the accessed data, and (iii) concatenating the embeddings for the representation using latent representation vectors.

In yet another embodiment, the method further includes training (210) a ML model to learn to discriminate between respective pairs in the plurality of first pairs of ARPs in the first representation which are to be contrasted to verify the similarity of a respective second pair in the planned target network.

In some embodiments, the selecting (222) a subset of the second pairs of ARPs includes (i) generating the plurality of first pairs of ARPs in the source network identified as similar or dissimilar, (ii) from the generated plurality of first plurality of first pairs of ARPs identified as similar or dissimilar, training the ML model on the identified first pairs of ARPs, (iii) using the trained ML model to generate a plurality of second pairs of ARPs in the planned target network and compare the generated plurality of second pairs of ARPs with the first plurality of first pairs if ARPs in the source network identified as similar or dissimilar, and (iv) labeling respective pairs in the plurality of second pairs of ARPs the planned target network as at least one of a candidate reliable pair and a candidate unreliable pair.

An ARP can be included in a node, and the selecting (222) a subset of the second pairs of ARPs that define the over the air synchronization topology in the planned target network can include (i) constructing a graph of the candidate reliable pairs, (ii) identifying a minimum number of nodes that reach all other nodes in the graph, and (iii) labeling the minimum number of nodes as the selected subset of the second pairs of ARPs.

In some embodiments, to identify (206) the plurality of first pairs of ARPs in the source network is based on the method further includes accessing (200) data from the source network comprising configuration management and performance data; and extracting (202) data from the accessed data comprising, per pair of ARPs in the plurality of first pairs of ARPs, at least one of a cell configuration, a position of an antenna in the ARPs, a signal quality, a signal path loss, and a time alignment error measurement.

In another embodiment, the plurality of second pairs of ARPs in the planned target network are identified based on the method further including accessing (212) data for the planned target network including configuration management and performance data; and extracting data (214) from the accessed data including, per pair of ARPs in the plurality of second pairs of ARPs, at least one of a cell configuration, a position of an antenna in the ARPs, an expected signal quality, and an expected signal path loss.

In some embodiments, the generating (220) a second representation of the plurality of second pairs of ARPs in the planned target network classified as similar is based on the method further including extracting (204, 216) spatial infrastructure data of a geographic region of the planned target network comprising at least one of a building footprint, a point of interest, land use information, and a type of terrain.

In another embodiment, the identifying (206) the plurality of first pairs of ARPs in the source network are identified from a plurality of historical time-series measurement including time alignment error data of a pair from the plurality of first pairs of ARPs in the source network.

In some embodiments, the trained ML model includes at least one neural network that learns to discriminate between respective pairs in the plurality of first pairs of ARPs in the first representation which are then contrasted to verify the similarity of a respective second pair in the planned target network.

In some embodiments, the at least one neural network includes a Siamese neural network including two identical deep neural networks, and the training the ML model to learn similarities between respective pairs in the plurality of pairs of ARPs in the first representation includes (i) comparing respective latent representation vectors for two pairs of ARPs from the plurality of first pairs of ARPs from the first representation to obtain a similarity score, (ii) based on the comparing, the similarity score comprises a score identifying the two pairs of ARPs as similar when the two pairs share a same label, and (iii) based on the comparing, the similarity score comprises a score identifying the two pairs of ARPs as dissimilar when the pairs have different labels.

In some embodiments, the criteria includes the minimum number of ARPS from the respective pairs classified as similar reach a remaining number of ARPs from the respective pairs within a specified number of hops away.

In some embodiments, the method further includes identifying (224), from the subset of the second pairs of ARPs, an anchor node in the planned target network.

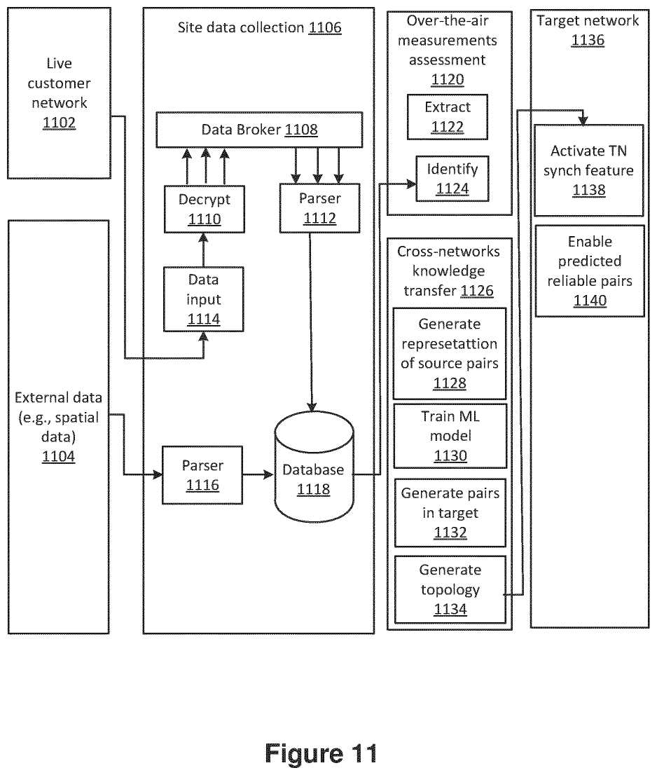

FIG. 11 is a block diagram of a cloud environment in which some embodiments of the present disclosure can be implemented. For example, the ML model and other components for performing some embodiments can be deployed in a cloud environment including, without limitation, a decoupling of components for three groups of operations (1) data collection (e.g., at site data collection 1106); (2) network synchronization feature assessment (e.g., at over-the-air measurements assessment component 1120); and (3) learning similarity and cross-networks knowledge transfer (e.g., in target network 1136).

As shown in the example of FIG. 11, a live customer network 1102 (e.g., a mobile network) and external data 1104 (e.g., spatial data such as urban infrastructure data) are communicatively connected to a site data collection 1106. In this example, site data collection 1106 includes data broker 1108, which receives data input 1114 (from live customer network 1102) that is decrypted by a decryption component 1110. Data broker 1108 outputs decrypted data to parser component 1112, and parser 1112 provides parsed data to database 1118. External data 1104 is provided to parser 1116, and parser 1116 also provides parsed data to database 1118.

Data from database 1118 of site data collection 1106 is provided to identify 1124 component in over-the-air measurements assessment component 1120. In this example, identify component 1124 identifies robust and reliable node ARP pairs. over-the-air measurements assessment component also includes extract component 1122. Extract component 1122 extract synchronization node ARP data from the source network.

In this example, over-the-air measurements assessment component 1120 also includes cross-knowledge transfer component 1126. Cross-knowledge transfer component 1126 includes components that generate 1128 representations for reliable node ARP pairs; train 1130 a ML model to learn similarity between node ARP pairs; generate 1132 node ARP pairs in the target network; and synchronization network topology generation 1134. A generated synchronization network topology is provided to target network 1136.

In this example, target network 1136 includes an activate over-the-air synchronization feature 1138 (which receives the generated synchronization network topology, as shown in FIG. 11); and a component 1140 that enables determination (e.g., prediction) of reliable pairs for the target network.

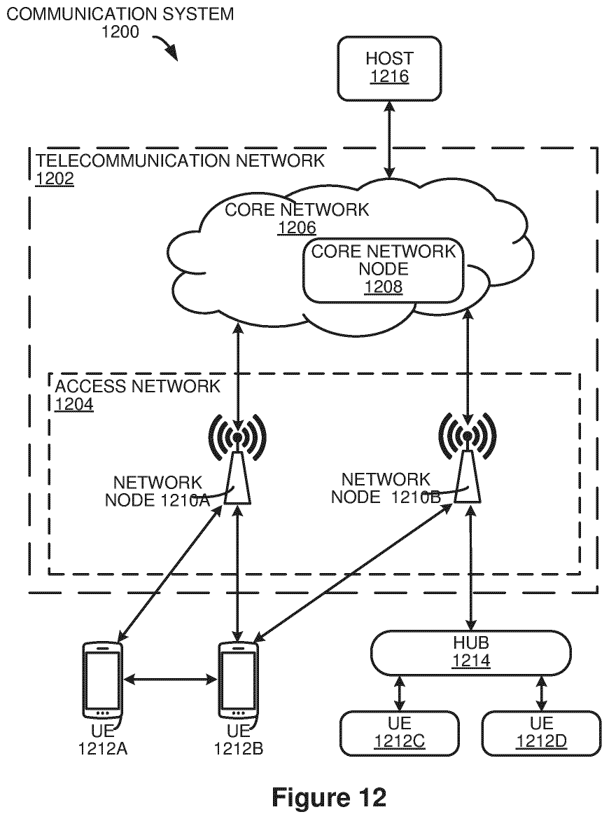

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

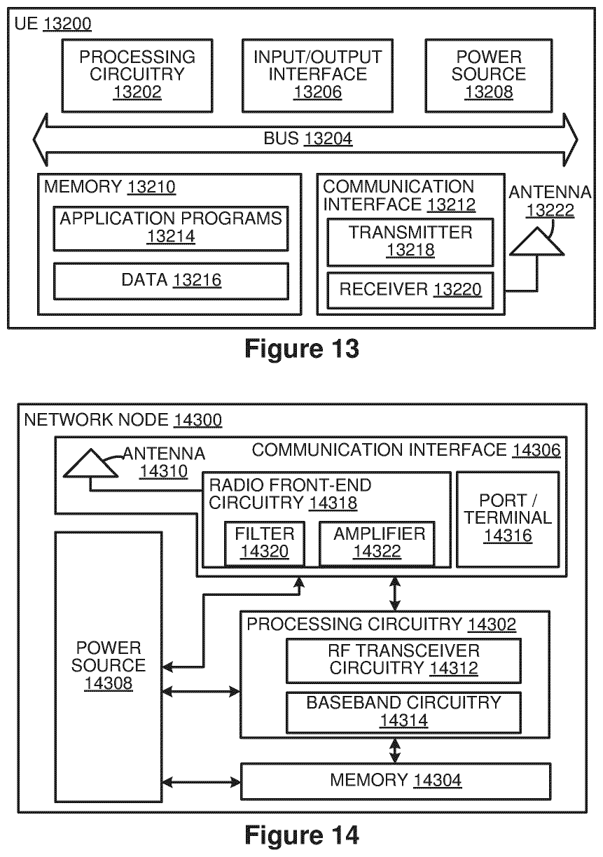

FIG. 13 shows a UE 13200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 13200 includes processing circuitry 13202 that is operatively coupled via a bus 13204 to an input/output interface 13206, a power source 13208, a memory 13210, a communication interface 13212, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 13202 is configured to process instructions and data and may be configured to implement any sequential state machine operative to execute instructions stored as machine-readable computer programs in the memory 13210. The processing circuitry 13202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 13202 may include multiple central processing units (CPUs).

In the example, the input/output interface 13206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 13200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 13208 is structured as a battery or battery pack. Other types of power sources, such as an external power source (e.g., an electricity outlet), photovoltaic device, or power cell, may be used. The power source 13208 may further include power circuitry for delivering power from the power source 13208 itself, and/or an external power source, to the various parts of the UE 13200 via input circuitry or an interface such as an electrical power cable. Delivering power may be, for example, for charging of the power source 13208. Power circuitry may perform any formatting, converting, or other modification to the power from the power source 13208 to make the power suitable for the respective components of the UE 13200 to which power is supplied.

The memory 13210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 13210 includes one or more application programs 13214, such as an operating system, web browser application, a widget, gadget engine, or other application, and corresponding data 13216. The memory 13210 may store, for use by the UE 13200, any of a variety of various operating systems or combinations of operating systems.

The memory 13210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 13210 may allow the UE 13200 to access instructions, application programs and the like, stored on transitory or non-transitory memory media, to off-load data, or to upload data. An article of manufacture, such as one utilizing a communication system may be tangibly embodied as or in the memory 13210, which may be or comprise a device-readable storage medium.

The processing circuitry 13202 may be configured to communicate with an access network or other network using the communication interface 13212. The communication interface 13212 may comprise one or more communication subsystems and may include or be communicatively coupled to an antenna 13222. The communication interface 13212 may include one or more transceivers used to communicate, such as by communicating with one or more remote transceivers of another device capable of wireless communication (e.g., another UE or a network node in an access network). Each transceiver may include a transmitter 13218 and/or a receiver 13220 appropriate to provide network communications (e.g., optical, electrical, frequency allocations, and so forth). Moreover, the transmitter 13218 and receiver 13220 may be coupled to one or more antennas (e.g., antenna 13222) and may share circuit components, software or firmware, or alternatively be implemented separately.

In the illustrated embodiment, communication functions of the communication interface 13212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 13212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 13200 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 14300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 14300 includes a processing circuitry 14302, a memory 14304, a communication interface 14306, and a power source 14308. The network node 14300 may be composed of multiple physically separate components (e.g., a NodeB component and a RNC component, or a BTS component and a BSC component, etc.), which may each have their own respective components. In certain scenarios in which the network node 14300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 14300 may be configured to support multiple radio access technologies (RATs). In such embodiments, some components may be duplicated (e.g., separate memory 14304 for different RATs) and some components may be reused (e.g., a same antenna 14310 may be shared by different RATs). The network node 14300 may also include multiple sets of the various illustrated components for different wireless technologies integrated into network node 14300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 14300.

The processing circuitry 14302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 14300 components, such as the memory 14304, to provide network node 14300 functionality.

In some embodiments, the processing circuitry 14302 includes a system on a chip (SOC). In some embodiments, the processing circuitry 14302 includes one or more of radio frequency (RF) transceiver circuitry 14312 and baseband processing circuitry 14314. In some embodiments, the radio frequency (RF) transceiver circuitry 14312 and the baseband processing circuitry 14314 may be on separate chips (or sets of chips), boards, or units, such as radio units and digital units. In alternative embodiments, part or all of RF transceiver circuitry 14312 and baseband processing circuitry 14314 may be on the same chip or set of chips, boards, or units.

The memory 14304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 14302. The memory 14304 may store any suitable instructions, data, or information, including a computer program, software, an application including one or more of logic, rules, code, tables, and/or other instructions capable of being executed by the processing circuitry 14302 and utilized by the network node 14300. The memory 14304 may be used to store any calculations made by the processing circuitry 14302 and/or any data received via the communication interface 14306. In some embodiments, the processing circuitry 14302 and memory 14304 is integrated.

The communication interface 14306 is used in wired or wireless communication of signaling and/or data between a network node, access network, and/or UE. As illustrated, the communication interface 14306 comprises port(s)/terminal(s) 14316 to send and receive data, for example to and from a network over a wired connection. The communication interface 14306 also includes radio front-end circuitry 14318 that may be coupled to, or in certain embodiments a part of, the antenna 14310. Radio front-end circuitry 14318 comprises filters 14320 and amplifiers 14322. The radio front-end circuitry 14318 may be connected to an antenna 14310 and processing circuitry 14302. The radio front-end circuitry may be configured to condition signals communicated between antenna 14310 and processing circuitry 14302. The radio front-end circuitry 14318 may receive digital data that is to be sent out to other network nodes or UEs via a wireless connection. The radio front-end circuitry 14318 may convert the digital data into a radio signal having the appropriate channel and bandwidth parameters using a combination of filters 14320 and/or amplifiers 14322. The radio signal may then be transmitted via the antenna 14310. Similarly, when receiving data, the antenna 14310 may collect radio signals which are then converted into digital data by the radio front-end circuitry 14318. The digital data may be passed to the processing circuitry 14302. In other embodiments, the communication interface may comprise different components and/or different combinations of components.

In certain alternative embodiments, the network node 14300 does not include separate radio front-end circuitry 14318, instead, the processing circuitry 14302 includes radio front-end circuitry and is connected to the antenna 14310. Similarly, in some embodiments, all or some of the RF transceiver circuitry 14312 is part of the communication interface 14306. In still other embodiments, the communication interface 14306 includes one or more ports or terminals 14316, the radio front-end circuitry 14318, and the RF transceiver circuitry 14312, as part of a radio unit (not shown), and the communication interface 14306 communicates with the baseband processing circuitry 14314, which is part of a digital unit (not shown).

The antenna 14310 may include one or more antennas, or antenna arrays, configured to send and/or receive wireless signals. The antenna 14310 may be coupled to the radio front-end circuitry 14318 and may be any type of antenna capable of transmitting and receiving data and/or signals wirelessly. In certain embodiments, the antenna 14310 is separate from the network node 14300 and connectable to the network node 14300 through an interface or port.

The antenna 14310, communication interface 14306, and/or the processing circuitry 14302 may be configured to perform any receiving operations and/or certain obtaining operations described herein as being performed by the network node. Any information, data and/or signals may be received from a UE, another network node and/or any other network equipment. Similarly, the antenna 14310, the communication interface 14306, and/or the processing circuitry 14302 may be configured to perform any transmitting operations described herein as being performed by the network node. Any information, data and/or signals may be transmitted to a UE, another network node and/or any other network equipment.

The power source 14308 provides power to the various components of network node 14300 in a form suitable for the respective components (e.g., at a voltage and current level needed for each respective component). The power source 14308 may further comprise, or be coupled to, power management circuitry to supply the components of the network node 14300 with power for performing the functionality described herein. For example, the network node 14300 may be connectable to an external power source (e.g., the power grid, an electricity outlet) via an input circuitry or interface such as an electrical cable, whereby the external power source supplies power to power circuitry of the power source 14308. As a further example, the power source 14308 may comprise a source of power in the form of a battery or battery pack which is connected to, or integrated in, power circuitry. The battery may provide backup power should the external power source fail.

Embodiments of the network node 14300 may include additional components beyond those shown in FIG. 14 for providing certain aspects of the network node's functionality, including any of the functionality described herein and/or any functionality necessary to support the subject matter described herein. For example, the network node 14300 may include user interface equipment to allow input of information into the network node 14300 and to allow output of information from the network node 14300. This may allow a user to perform diagnostic, maintenance, repair, and other administrative functions for the network node 14300.

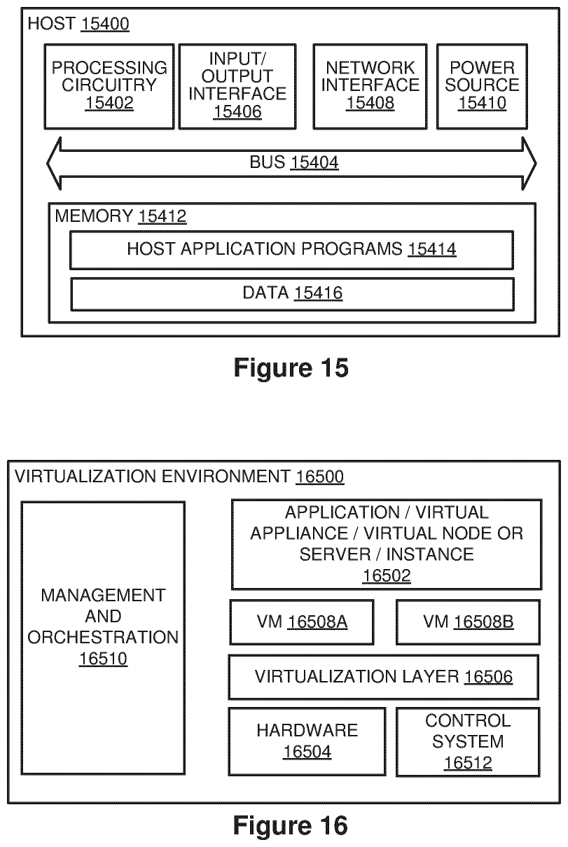

FIG. 15 is a block diagram of a host 15400, which may be an embodiment of the host 1216 of FIG. 12, in accordance with various aspects described herein. As used herein, the host 15400 may be or comprise various combinations hardware and/or software, including a standalone server, a blade server, a cloud-implemented server, a distributed server, a virtual machine, container, or processing resources in a server farm. The host 15400 may provide one or more services to one or more UEs.

The host 15400 includes processing circuitry 15402 that is operatively coupled via a bus 15404 to an input/output interface 15406, a network interface 15408, a power source 15410, and a memory 15412. Other components may be included in other embodiments. Features of these components may be substantially similar to those described with respect to the devices of previous figures, such as FIGS. 13 and 14, such that the descriptions thereof are generally applicable to the corresponding components of host 15400.

The memory 15412 may include one or more computer programs including one or more host application programs 15414 and data 15416, which may include user data, e.g., data generated by a UE for the host 15400 or data generated by the host 15400 for a UE. Embodiments of the host 15400 may utilize only a subset or all of the components shown. The host application programs 15414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 15414 may also provide for user authentication and licensing checks and may periodically report health, routes, and content availability to a central node, such as a device in or on the edge of a core network. Accordingly, the host 15400 may select and/or indicate a different host for over-the-top services for a UE. The host application programs 15414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 16500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 16500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 16502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 16504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 16506 (also referred to as hypervisors or virtual machine monitors (VMMs)), provide VMs 16508a and 16508b (one or more of which may be generally referred to as VMs 16508), and/or perform any of the functions, features and/or benefits described in relation with some embodiments described herein. The virtualization layer 16506 may present a virtual operating platform that appears like networking hardware to the VMs 16508.

The VMs 16508 comprise virtual processing, virtual memory, virtual networking or interface and virtual storage, and may be run by a corresponding virtualization layer 16506. Different embodiments of the instance of a virtual appliance 16502 may be implemented on one or more of VMs 16508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 16508 may be a software implementation of a physical machine that runs programs as if they were executing on a physical, non-virtualized machine. Each of the VMs 16508, and that part of hardware 16504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 16508 on top of the hardware 16504 and corresponds to the application 16502.

Hardware 16504 may be implemented in a standalone network node with generic or specific components. Hardware 16504 may implement some functions via virtualization. Alternatively, hardware 16504 may be part of a larger cluster of hardware (e.g. such as in a data center or CPE) where many hardware nodes work together and are managed via management and orchestration 16510, which, among others, oversees lifecycle management of applications 16502. In some embodiments, hardware 16504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

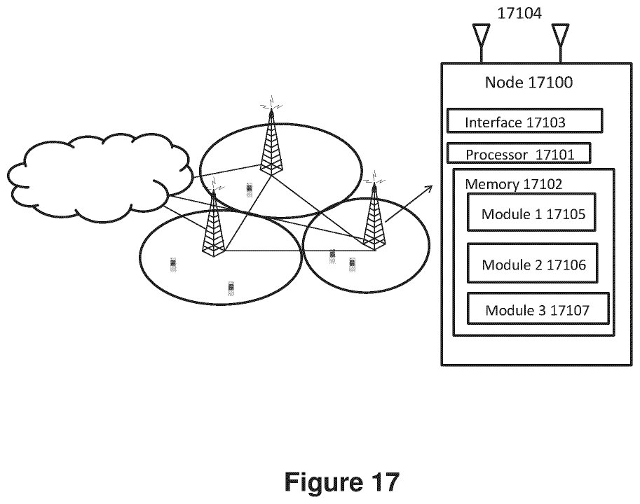

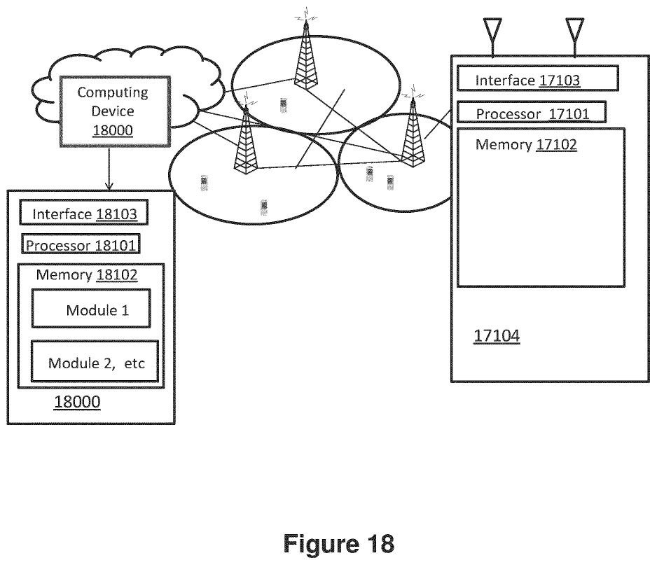

Referring to FIG. 17, the computing device can be node 17100.

Computing device 17100 may, in some embodiments, be an electronic device that can be communicatively connected to other electronic devices on the network (e.g., other computing devices, UEs) radio base stations, etc.). In certain embodiments, node 17100 may include radio access features that provide wireless radio network access to other electronic devices (for example a “radio access computing device” may refer to such a computing device) such as UEs. For example, node 17100 may be a base station, such as eNodeB in LTE, NodeB in Wideband Code Division Multiple Access (WCDMA) or other types of base stations, as well as a Radio Network Controller (RNC), a Base Station Controller (BSC), or other types of control nodes. As depicted in FIG. 17, the example node 17100 comprises processor 17101, memory 17102, interface 17103, and antenna 17104. These components may work together to provide various computing device functionality as disclosed herein.

Processor 17101 may be a microprocessor, controller, microcontroller, central processing unit, digital signal processor, application specific integrated circuit, field programmable gate array, any other type of electronic circuitry, or any combination of one or more of the preceding. The processor 17101 may comprise one or more processor cores. In particular embodiments, some or all of the functionality described herein as being provided by node 17100 may be implemented by processor 17101 executing software instructions, either alone or in conjunction with other node 17100 components, such as memory 17102.

Memory 17102 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals—such as carrier waves, infrared signals). For instance, memory 17102 may comprise non-volatile memory containing code to be executed by processor 17101. Where memory 17102 is non-volatile, the code and/or data stored therein can persist even when the computing device is turned off (when power is removed). In some instances, while node 17100 is turned on that part of the code that is to be executed by the processor(s) 17101 may be copied from non-volatile memory into volatile memory (e.g., dynamic random access memory (DRAM), static random access memory (SRAM)) of node 17100.

Interface 17103 may be used in the wired and/or wireless communication of signaling and/or data to or from node 17100. For example, interface 17103 may perform any formatting, coding, or translating to allow node 17100 to send and receive data whether over a wired and/or a wireless connection. In some embodiments, interface 17103 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas 17104 to the appropriate recipient(s). In some embodiments, interface 17103 may comprise network interface controller(s) (NICs), also known as a network interface card, network adapter, local area network (LAN) adapter or physical network interface. The NIC(s) may facilitate in connecting the node 17100 to other devices allowing them to communicate via wire through plugging in a cable to a physical port connected to a NIC. As explained above, in particular embodiments, processor 17101 may represent part of interface 17103, and some or all of the functionality described as being provided by interface X103 may be provided more specifically by processor 17101.

The components of node 17100 are each depicted as separate boxes located within a single larger box for reasons of simplicity in describing certain aspects and features of node 17100 disclosed herein. In practice however, one or more of the components illustrated in the example node 17100 may comprise multiple different physical elements (e.g., interface 17103 may comprise terminals for coupling wires for a wired connection and a radio transceiver for a wireless connection).

Methods of the present disclosure solution described herein may thus be implemented in the node 17100 by means of a computer program comprising instructions which, when executed on at least one processor, cause the at least one processor to carry out the actions according to any of the above features and embodiments, where appropriate.

While the modules are illustrated as being implemented in software stored in memory 17102, other embodiments implement part or all of each of these modules in hardware.

FIG. 18 is a schematic diagram illustrating an implementation of a computing device 18000 in the cloud. For example, computing device 18000 may be a server, a distributed base station, a site data collection node, a synchronization feature assessment node, and/or a node for a target deployment. As depicted in FIG. 18, the example computing device 18000 comprises processor 18101, memory 18102, interface 18103, and antenna 18104. These components may work together to provide various computing device functionality as disclosed herein.

Processor 18101 may be a microprocessor, controller, microcontroller, central processing unit, digital signal processor, application specific integrated circuit, field programmable gate array, any other type of electronic circuitry, or any combination of one or more of the preceding. The processor 18101 may comprise one or more processor cores. In particular embodiments, some or all of the functionality described herein as being provided by computing device 18000 may be implemented by processor 18101 executing software instructions, either alone or in conjunction with other computing device 18000 components, such as memory 18102.

Memory 18102 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals—such as carrier waves, infrared signals). For instance, memory 18102 may comprise non-volatile memory containing code to be executed by processor 18101. Where memory 18102 is non-volatile, the code and/or data stored therein can persist even when the computing device is turned off (when power is removed). In some instances, while computing device 18000 is turned on that part of the code that is to be executed by the processor(s) 18101 may be copied from non-volatile memory into volatile memory (e.g., dynamic random access memory (DRAM), static random access memory (SRAM)) of computing device 18000.

Interface 18103 may be used in the wired and/or wireless communication of signaling and/or data to or from computing device 18000. For example, interface 18103 may perform any formatting, coding, or translating to allow computing device 18000 to send and receive data whether over a wired and/or a wireless connection. In some embodiments, interface 18103 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas 18104 to the appropriate recipient(s). In some embodiments, interface 18103 may comprise network interface controller(s) (NICs), also known as a network interface card, network adapter, local area network (LAN) adapter or physical network interface. The NIC(s) may facilitate in connecting the computing device 18000 to other devices allowing them to communicate via wire through plugging in a cable to a physical port connected to a NIC. As explained above, in particular embodiments, processor 18101 may represent part of interface 18103, and some or all of the functionality described as being provided by an interface may be provided more specifically by processor 18101.

The components of computing device 18000 are each depicted as separate boxes located within a single larger box for reasons of simplicity in describing certain aspects and features of computing device 18000 disclosed herein. In practice however, one or more of the components illustrated in the example computing device 18000 may comprise multiple different physical elements (e.g., interface 18103 may comprise an over the air interface).

Methods of the present disclosure solution described herein may thus be implemented in the computing device 18000 by means of a computer program comprising instructions which, when executed on at least one processor, cause the at least one processor to carry out the actions according to any of the above features and embodiments, where appropriate.

While the modules are illustrated as being implemented in software stored in memory 18102, other embodiments implement part or all of each of these modules in hardware.

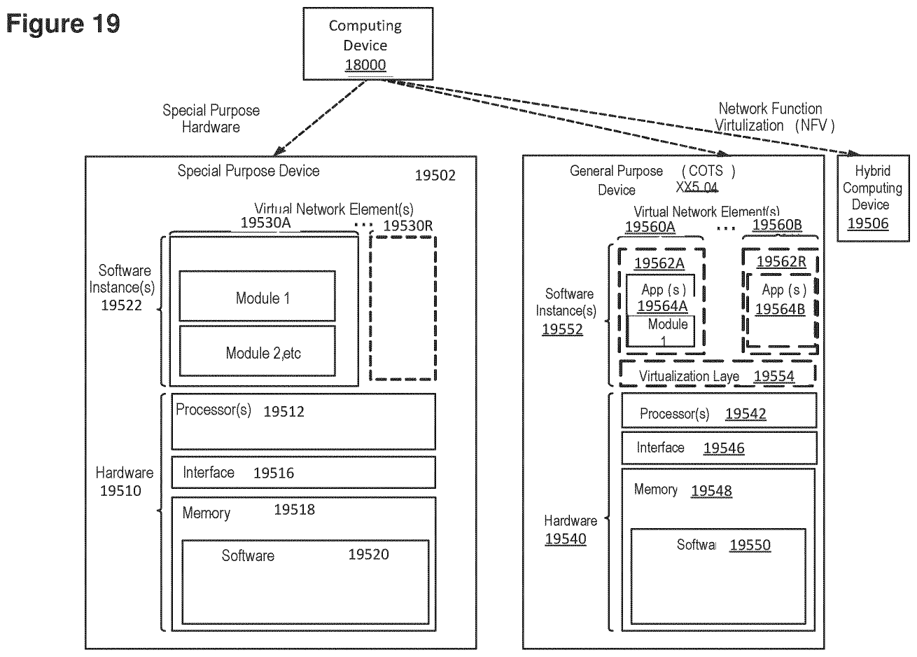

FIG. 19 illustrates two specific examples of how computing device 18000 may be implemented in certain embodiments of the present disclosure including: 1) a special-purpose computing device 19502 that uses custom processing circuits such as application-specific integrated-circuits (ASICs) and a proprietary operating system (OS); and 2) a general purpose computing device 19504 that uses common off-the-shelf (COTS) processors and a standard OS which has been configured to provide one or more of the features or functions disclosed herein.

Special-purpose computing device 19502 includes hardware 19510 comprising processor(s) 19512, and interface 19516, as well as memory 19518 having stored therein software 19520. In one embodiment, the software 19520 implements the modules described with regard to the previous figures. During operation, the software 19520 may be executed by the hardware 19510 to instantiate a set of one or more software instance(s) 19522. Each of the software instance(s) 19522, and that part of the hardware 19510 that executes that software instance (be it hardware dedicated to that software instance, hardware in which a portion of available physical resources (e.g., a processor core) is used, and/or time slices of hardware temporally shared by that software instance with others of the software instance(s) 19522), form a separate virtual network element 19530A-R. Thus, in the case where there are multiple virtual network elements 19530A-R, each operates as one of the computing devices from the preceding figures.

Returning to FIG. 19, the example general purpose computing device 19504 includes hardware 19540 comprising a set of one or more processor(s) 19542 (which are often COTS processors) and interface 19546, as well as memory 19548 having stored therein software 19550. During operation, the processor(s) 19542 execute the software 19550 to instantiate one or more sets of one or more applications 19564A-R. While certain embodiments do not implement virtualization, alternative embodiments may use different forms of virtualization. For example, in certain alternative embodiments virtualization layer 19554 represents the kernel of an operating system (or a shim executing on a base operating system) that allows for the creation of multiple instances 19562A-R called software containers that may each be used to execute one (or more) of the sets of applications 19564A-R. In this embodiment, software containers 19562A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer 19554 may represent a hypervisor (sometimes referred to as a virtual machine monitor (VMM)) or a hypervisor executing on top of a host operating system; and each of the sets of applications 19564A-R may run on top of a guest operating system within an instance 19562A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 19540, directly on a hypervisor (in which case the unikernel is sometimes described as running within a LibOS virtual machine), or in a software container, embodiments can be implemented fully with unikernels running directly on a hypervisor represented by virtualization layer 19554, unikernels running within software containers represented by instances 19562A-R, or as a combination of unikernels and the above-described techniques (e.g., unikernels and virtual machines both run directly on a hypervisor, unikernels and sets of applications that are run in different software containers).

The instantiation of the one or more sets of one or more applications 19564A-R, as well as virtualization if implemented are collectively referred to as software instance(s) 19552. Each set of applications 19564A-R, corresponding virtualization construct (e.g., instance 19562A-R) if implemented, and that part of the hardware 19540 that executes them (be it hardware dedicated to that execution and/or time slices of hardware temporally shared by software containers 19562A-R), forms a separate virtual network element(s) 19560A-R.

The virtual network element(s) 19560A-R perform similar functionality to the virtual network element(s) 19530A-R. This virtualization of the hardware 19540 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the invention may implement one or more of the software container(s) 19562A-R differently. While embodiments of the invention are illustrated with each instance 19562A-R corresponding to one VNE 19560A-R, alternative embodiments may implement this correspondence at a finer level granularity; it should be understood that the techniques described herein with reference to a correspondence of instances 19562A-R to VNEs also apply to embodiments where such a finer level of granularity and/or unikernels are used.

The third exemplary ND implementation in FIG. 19 is a hybrid computing device 19506, which includes both custom ASICs/proprietary OS and COTS processors/standard OS in a single ND or a single card within an ND. In certain embodiments of such a hybrid computing device, a platform virtual machine (VM), such as a VM that that implements the functionality of the special-purpose computing device 19502, could provide for para-virtualization to the hardware present in the hybrid computing device 19506.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method performed by a computing device to select a over the air network synchronization topology in a planned target network, the method comprising:
identifying a plurality of first pairs of antenna reference points, ARPs, in a source network;
generating a first representation of the plurality of first pairs of ARPs in the source network;
generating a second representation of a plurality of second pairs of ARPs in the planned target network;
using a trained machine learning, ML, model comprising transferred knowledge of learned similarities between the plurality of first pairs of ARPs in the first representation, to classify respective pairs as at least one of similar and dissimilar from the second representation of the plurality of second pairs of ARPs in the planned target network; and
selecting a subset of the second pairs of ARPs based on an identification of a minimum number of ARPs from the respective pairs classified as similar that meet a criteria, wherein the selected subset defines the over the air network synchronization topology in the planned target network.

2. The method of claim 1, wherein the knowledge comprises antenna data and radio environment data from the source network.

3. The method of claim 1, wherein the identifying the plurality of first pairs of ARPs comprises (i) labeling a plurality of historical time-series measurements comprising time alignment error data of a pair from the plurality of first pairs of ARPs as at least one of reliable and unreliable, (ii) identify and label unreliable and reliable ARP pairs, and (iii) use labeled ARP pairs to select pairs of second pairs of ARPs.

4. The method of claim 3, wherein the identifying further comprises (i) identifying a plurality of cycles in the first representation of the plurality of first pairs of ARPs in the source network, wherein a cycle comprises a time difference between respective ARPs in a group of three or more ARPs, (ii) calculating a sum of the time differences per cycle in the source network, (iii) comparing the sum of the time differences per cycle to a specified cycle threshold, (iv) when a cycle satisfies the cycle threshold, flagging the cycle as acceptable and marking a plurality of edges in the cycle as reliable, (v) when a cycle fails to satisfy the cycle threshold, flagging the cycle as unacceptable and marking a plurality of edges in the cycle as unreliable, and (vi) If an edge is present both in an unacceptable cycle and in an acceptable cycle, the edge is considered reliable.

5. The method of claim 1, wherein the generating a first representation of the plurality of first pairs of ARPs in the source network comprises (i) accessing for a pair of ARPs from the first pair of ARPs, data comprising a cell configuration, synchronization key performance indicators, KPIs, comprising an over the air time alignment measurement and spatial contextual data, (ii) generating embeddings using the accessed data, and (iii) concatenating the embeddings for the representation using latent representation vectors.

6. The method of claim 1, further comprising:
training a ML model to learn to discriminate between respective pairs in the plurality of first pairs of ARPs in the first representation which are to be contrasted to verify the similarity of a respective second pair in the planned target network.

7. The method of claim 1, wherein selecting a subset of the second pairs of ARPs includes (i) generating the plurality of first pairs of ARPs in the source network identified as similar or dissimilar, (ii) from the generated plurality of first plurality of first pairs of ARPs identified as similar or dissimilar, training the ML model on the identified first pairs of ARPs, (iii) using the trained ML model to generate a plurality of second pairs of ARPs in the planned target network and compare the generated plurality of second pairs of ARPs with the first plurality of first pairs if ARPs in the source network identified as similar or dissimilar, and (iv) labeling respective pairs in the plurality of second pairs of ARPs the planned target network as at least one of a candidate reliable pair and a candidate unreliable pair.

8. The method of claim 1, wherein an ARP is included in a node, and wherein the selecting a subset of the second pairs of ARPs that define the over the air synchronization topology in the planned target network comprises (i) constructing a graph of the candidate reliable pairs, (ii) identifying a minimum number of nodes that reach all other nodes in the graph, and (iii) labeling the minimum number of nodes as the selected subset of the second pairs of ARPs.

9. The method of claim 1, wherein to identify the plurality of first pairs of ARPs in the source network is based on the method further comprising:
accessing data from the source network comprising configuration management and performance data; and
extracting data from the accessed data comprising, per pair of ARPs in the plurality of first pairs of ARPs, at least one of a cell configuration, a position of an antenna in the ARPs, a signal quality, a signal path loss, and a time alignment error measurement.

10. The method of claim 1, wherein the plurality of second pairs of ARPs in the planned target network are identified based on the method further comprising:
accessing data for the planned target network comprising configuration management and performance data; and
extracting data from the accessed data comprising, per pair of ARPs in the plurality of second pairs of ARPs, at least one of a cell configuration, a position of an antenna in the ARPs, an expected signal quality, and an expected signal path loss.

11. The method of claim 1, wherein the generating a second representation of the plurality of second pairs of ARPs in the planned target network classified as similar is based on the method further comprising:
extracting spatial infrastructure data of a geographic region of the planned target network comprising at least one of a building footprint, a point of interest, land use information, and a type of terrain.

12. The method of claim 3, wherein the identifying the plurality of first pairs of ARPs in the source network are identified from a plurality of historical time-series measurement comprising time alignment error data of a pair from the plurality of first pairs of ARPs in the source network.

13. The method of claim 6, wherein the trained ML model comprises at least one neural network that learns to discriminate between respective pairs in the plurality of first pairs of ARPs in the first representation which are then contrasted to verify the similarity of a respective second pair in the planned target network.

14. The method of claim 13, wherein the at least one neural network comprises a Siamese neural network comprising two identical deep neural networks, and the training the ML model to learn similarities between respective pairs in the plurality of pairs of ARPs in the first representation comprises (i) comparing respective latent representation vectors for two pairs of ARPs from the plurality of first pairs of ARPs from the first representation to obtain a similarity score, (ii) based on the comparing, the similarity score comprises a score identifying the two pairs of ARPs as similar when the two pairs share a same label, and (iii) based on the comparing, the similarity score comprises a score identifying the two pairs of ARPs as dissimilar when the pairs have different labels.

15. The method of claim 1, wherein the computing device comprises one of a centralized computing device communicatively connected to the source network and the planned target network, and a distributed cloud-based computing devices comprising one or more of the following modules (i) a data collection module, (ii) a transport network synchronization feature assessment module, and (iii) a cross-network knowledge transfer module.

16. The method of claim 1, wherein the criteria comprises the minimum number of ARPS from the respective pairs classified as similar reach a remaining number of ARPs from the respective pairs within a specified number of hops away.

17. The method of claim 1, further comprising:
identifying, from the subset of the second pairs of ARPs, an anchor node in the planned target network.

18. A computing device configured to select an over the air network synchronization topology in a planned target network, the computing device comprising:
processing circuitry;
memory coupled with the processing circuitry, wherein the memory includes instructions that when executed by the processing circuitry causes the computing device to perform operations comprising:
identify a plurality of first pairs of antenna reference points, ARPs, in a source network;
generate a first representation of the plurality of first pairs of ARPs in the source network;
generate a second representation of a plurality of second pairs of ARPs in the planned target network;
use a trained machine learning, ML, model comprising transferred knowledge of learned similarities between the plurality of first pairs of ARPs in the first representation, to classify respective pairs as at least one of similar and dissimilar from the second representation of the plurality of second pairs of ARPs in the planned target network; and
select a subset of the second pairs of ARPs based on an identification of a minimum number of ARPs from the respective pairs classified as similar that meet a criteria, wherein the selected subset defines the over the air network synchronization topology in the planned target network.

19. The computing device of claim 18, wherein the memory includes instructions that when executed by the processing circuitry causes the computing device to perform further operations comprising:
identifying a plurality of first pairs of antenna reference points, ARPs, in a source network;
generating a first representation of the plurality of first pairs of ARPs in the source network;
generating a second representation of a plurality of second pairs of ARPs in the planned target network;
using a trained machine learning, ML, model comprising transferred knowledge of learned similarities between the plurality of first pairs of ARPs in the first representation, to classify respective pairs as at least one of similar and dissimilar from the second representation of the plurality of second pairs of ARPs in the planned target network; and
selecting a subset of the second pairs of ARPs based on an identification of a minimum number of ARPs from the respective pairs classified as similar that meet a criteria, wherein the selected subset defines the over the air network synchronization topology in the planned target network,
wherein the knowledge comprises antenna data and radio environment data from the source network.

20. A computing device configured to select an over the air network synchronization topology in a planned target network, the computing device adapted to perform operations comprising:
identify a plurality of first pairs of antenna reference points, ARPs, in a source network;
generate a first representation of the plurality of first pairs of ARPs in the source network;
generate a second representation of a plurality of second pairs of ARPs in the planned target network;
use a trained machine learning, ML, model comprising transferred knowledge of learned similarities between the plurality of first pairs of ARPs in the first representation, to classify respective pairs as at least one of similar and dissimilar from the second representation of the plurality of second pairs of ARPs in the planned target network; and
select a subset of the second pairs of ARPs based on an identification of a minimum number of ARPs from the respective pairs classified as similar that meet a criteria, wherein the selected subset defines the a over the air network synchronization topology in the planned target network.

21-25. (canceled)
